(19) United States
(12) Patent Application Publication
(10) Pub. No.: US 2023/0094262 A1
(43) Pub. Date: Mar. 30, 2023

(54) DEVICE AND SYSTEM TO HOLD A FISHING ROD

(71) Applicant: JOHN MICHAEL ELLWOOD, Oak Hill, FL (US)

(72) Inventor: JOHN MICHAEL ELLWOOD, Oak Hill, FL (US)

(21) Appl. No.: 17/846,067

(22) Filed: Jun. 22, 2022

Related U.S. Application Data
(60) Provisional application No. 63/247,911, filed on Sep. 24, 2021.

(51) Int. Cl. A01K 97/10

(52) U.S. Cl. CPC A01K 97/10

(57) ABSTRACT

A device to hold a fishing rod and reel to assist a user with handling a fishing rod and reel in a hands-free manner. The device is made of a hollow tube for the fishing rod to fit into, connected to a leg plate and uses straps to tighten the device around one's leg and belt. A user of a device and system to hold a fishing rod and reel would place a leg plate against the outside of either their left or right leg and feed the straps around their leg. Connecting the straps will hold the device and system to hold a fishing rod and reel securely in place. A fishing rod handle can then be inserted downward into the hollow tube to allow a person to work on lures, untangle lines, or generally operate the fishing rod in a hands-free manner.

### RELATED APPLICATIONS

This application claims priority to U.S. Provisional Patent Application No. 63/232,497, filed on Aug. 16, 2021, and to U.S. Provisional Patent Application No. 63/247,911, filed on Sep. 24, 2021, which are incorporated herein by reference in their entirety, including any addendums, appendixes, and attachments thereto, to the extent these applications does not conflict with the present disclosure herein.

### BACKGROUND

The following discussion is not to be deemed admitted prior art but merely related art to show possible background and information related to fishing rods and reels.

When fishing, a challenge faced by a fishing enthusiast is one of where to lean a rod, lay down a rod, or hold a rod when working on the lures and bait.

Currently, there are solutions to use a fishing rod in a hands-free manner. Some of these solutions attempt to use a rod holder inserted in the ground, but this only works on the beach or a lake shore, not from inside a boat. Still other solutions have connected the rod and reel to a person's belt, but the center of gravity is often too high. Still other solutions use springs and clips to hold a rod in place. Yet, other solutions use harnesses and suspenders to hold a rod on a person.

Each of these solutions fail to meet the needed solution because they are difficult to use, cumbersome, uncomfortable, unreliable, and interfere with the normal handling and operation of the fishing rod and reel.

Therefore, a need exists for a novel device to hold a fishing rod and reel in a hands-free manner on one's person.

### BRIEF SUMMARY OF THE INVENTION

This invention relates generally to, but is not limited to, supporting a fishing rod and reel on a person to allow said person to have hands-free access to bait, untangle, or generally safely work on the rod and reel.

Disclosed are numerous aspects of a unique device and system to hold a fishing rod and reel.

It is desirable to have a device and system to attach to one's person that allows a fishing rod and reel to be held safely. Furthermore, it is desirable to have a device and system to attach to one's person that allows a fishing rod and reel to be held hands-free. Furthermore, it is desirable that a device to hold a fishing rod and reel be lightweight and comfortable.

Furthermore, it is desirable that a device and system to hold a fishing rod and reel be waterproof. Furthermore, it is desirable the components used to make a device and system to hold a fishing rod and reel resist exposure to both fresh water and salt water.

The disclosed invention advantageously fills these needs and addresses the aforementioned deficiencies by providing an easy to use, lightweight, comfortable, waterproof holder for a fishing rod.

### BRIEF DESCRIPTION OF THE DRAWINGS

A device to hold a fishing rod and reel is illustrated by way of example, and not by way of limitation, in the figures of the accompanying drawings.

While aspects of a device and system to hold a fishing rod and reel will be described with reference to the details of the embodiments of the invention shown in the drawings (and some embodiments not shown in the drawings), these details are not intended to limit the scope of the invention.

FIG. 1. A side view of a device and system to hold a fishing rod and reel, assembled without a spacer.

FIG. 2. A planar view of a device and system to hold a fishing rod and reel, assembled without a spacer.

FIG. 3. A side view of a device and system to hold a fishing rod and reel showing the unassembled components without a spacer.

FIG. 4. A planar view of a device and system to hold a fishing rod and reel showing the unassembled components without a spacer.

FIG. 5. A line drawing of a person with a device and system to hold a fishing rod and reel attached to the left leg with a fishing rod in the holder.

FIG. 6. A side view of a device and system to hold a fishing rod and reel including a spacer and belt strap, assembled with straps through the spacer.

FIG. 7. A planar view of a device and system to hold a fishing rod and reel including a spacer and belt strap, assembled with straps through the spacer.

FIG. 8. A side view of a device and system to hold a fishing rod and reel including a spacer and belt strap, unassembled.

FIG. 9. A planar view of a device and system to hold a fishing rod and reel including a spacer and belt strap, unassembled.

FIG. 10. A side view, rotated 90 degrees from FIG. 9, of a device and system to hold a fishing rod and reel including a spacer and belt strap, assembled.

FIG. 11. A side view of a device and system to hold a fishing rod and reel including a spacer and belt strap, assembled with straps around the hollow tube.

FIG. 12. A planar view of a device and system to hold a fishing rod and reel including a spacer and belt strap, assembled with straps around the hollow tube.

FIG. 13. A side view of a device and system to hold a fishing rod and reel including a spacer and belt strap, unassembled.

FIG. 14. A planar view of a device and system to hold a fishing rod and reel including a spacer and belt strap, unassembled.

FIG. 15. A side view, rotated 90 degrees from FIG. 11, of a device and system to hold a fishing rod and reel including a spacer and belt strap, assembled with straps around the hollow tube.

### LIST OF FIGURE ITEMS

000 A device and system to hold a fishing rod and reel
001 A hypothetical fishing rod
002 A hollow tube
003 A leg plate
004 A strap
005 A buckle
006 A belt strap
007 A spacer

### DETAILED DESCRIPTION

The order of the steps of disclosed processes may be altered within the scope of the invention.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. A device and system to hold a fishing rod and reel may, however, be embodied in many different forms and should not be construed as being limited to the embodiments set forth herein; rather, these embodiments are provided by way of illustration only and so that this disclosure will be thorough, complete and fully convey understanding to those skilled in the art.

For the purposes of promoting an understanding of the principles of a device to hold a fishing rod and reel, reference will now be made to the embodiments illustrated in the drawings and specific language will be used to describe the same, only as examples and not intended to be limiting.

Fishing rods and reels (hereafter referred to as “fishing rods”), as used herein may be, but are not limited to, offshore rods, surf rods, travel and pack rods, ice rods, center-pin and float rods, fly and spey rods, trolling rods, casting rods, or spinning rods.

Disclosed is a device and system to hold a fishing rod and reel, comprising the following components: (1) a hollow tube 002; (2) a leg plate 003; (3) two straps 004; (4) a buckle to secure the ends of each strap 005; (5) a mechanism to tighten the straps; (6) a spacer 007 connecting a hollow tube 002 to a leg plate 003; (7) a belt strap 006.

These components generally speaking, are configured as follows: (1) a hollow tube 002 is longitudinally and parallel connected to a leg plate 003; (2) parallel slots on the leg plate 003 exist for the straps 004 to pass through, (3) each of two straps 005 are fed through the slots in the leg plate 003 and around the hollow tube 002 in a perpendicular direction; (4) a belt strap 006 is inserted through a slot at the top end of the leg plate 003; (5) at one end of the straps 004 and 006 there is a buckle; (6) at the other end of the straps 004 and 006 there is another buckle 005 to secure the ends; (7) the buckle 005, or another method, allows the straps to be tightened by the user.

A device and system to hold a fishing rod and reel may also have one or more of the following: a single strap; a single wide strap; additional straps to accommodate longer and shorter versions of a device; notches or u-shaped channels in the hollow tube for a reel assembly to lock in place; a flared top end to received a fishing rod; a secondary system to tighten the straps; padding on the leg plate for comfort; custom-fitted leg plate molds; an additional belt strap to go around one's waist; a spacer between the hollow tube and the leg plate; a belt strap perpendicular to the leg straps to secure to one's belt; a hollow tube and a leg plate and a spacer as a single assembly.

The disclosed device and system to hold a fishing rod and reel is unique when compared with other known devices and solutions because it provides: (1) for operation without interfering with how the fishing rod and reel are used by the operator; (2) is reusable; (3) has no additional harnesses on one's body; (4) securely holds the rod; (5) operates one handed by just dropping the fishing rod into the device; (6) allows safe operation of a fishing rod and reel to avoid injury from hooks or lures.

The disclosed device and system to hold a fishing rod and reel is unique in that it is structurally different from other known devices or solutions. More specifically, the device is unique due to the presence of (1) a hollow tube that can vary in size and adapt to different fishing rods; (2) a hollow tube made of different materials; (3) a leg plate that can vary in size; (4) a leg plate made of different materials; (5) straps made of different materials; (6) a single strap or multiple straps, (7) couplings on the straps allowing for different configurations and connections; (8) a spacer between the hollow tube and the leg plate; (9) a single assembly comprising a hollow tube and a spacer and a leg plate.

Some embodiments of versions of a device and system to hold a fishing rod and reel comprise a hollow tube 002 connected to a leg plate 003; two straps 004; a belt strap 006; a buckle to secure the ends of each strap 005; a mechanism to tighten the straps.

In some embodiments of versions of a device to hold a fishing rod and reel a hollow tube 002 may vary in size, for example, and not meant to be limiting, having a height of 2 cm to 38 cm (approximately 1 inch to 15 inches) and a thickness of 0.3 cm to 5 cm (approximately ⅛ inch to 2 inches).

In some embodiments of versions of a device to hold a fishing rod and reel a hollow tube 002 is of a diameter equal to the outside diameter of a fishing rod handle. Fishing rod handles vary in size depending on the purpose of said fishing rod thus the diameter for example, and not meant to be limiting, of the tube may range from 2 cm to 10.5 cm (approximately 1 inch to 4 inches).

In some embodiments of versions of a device to hold a fishing rod and reel the hollow tube 002 may be flared at the upper end.

In some embodiments of versions of a device to hold a fishing rod and reel the hollow tube 002 may be made of materials like, but not limited to, metal, plastic, fiberglass, carbon fiber, rubber, foam, PVC (polyvinyl acetate), EVA (ethylene-vinyl acetate), and bamboo.

In some embodiments of versions of a device to hold a fishing rod and reel a leg plate 003 may vary in size, for example, and not meant to be limiting, having a height of 2 cm to 38 cm (approximately 1 inch to 15 inches), a width of 5 cm to 15 cm (approximately 2 inches to 6 inches), and a thickness of 0.6 cm to 5 cm (approximately ¼ inch to 2 inches).

In some embodiments of versions of a device to hold a fishing rod and reel the leg plate 003 may be curved and shaped for a leg whereas in other versions a leg plate may be flat.

In some embodiments of versions of a device to hold a fishing rod and reel the leg plate 003 may be custom molded for a particular user's leg.

In some embodiments of versions of a device to hold a fishing rod and reel a leg plate 003 material may be made of, but not limited to, metal, plastic, fiberglass, carbon fiber, rubber, foam, PVC (polyvinyl acetate), EVA (ethylene-vinyl acetate), and bamboo.

In some embodiments of versions of a device to hold a fishing rod and reel a spacer 007 may vary in size, for example, and not meant to be limiting, having a height of 2 cm to 38 cm (approximately 1 inch to 15 inches), a width of 1 cm to 15 cm (approximately ½ inches to 6 inches, and a thickness of 0.6 cm to 6 cm (approximately ¼ inch to 2 inches).

In some embodiments of versions of a device to hold a fishing rod and reel a spacer 007 may be a separate piece made of, but not limited to, metal, plastic, fiberglass, carbon fiber, rubber, foam, PVC (polyvinyl acetate), EVA (ethylene-vinyl acetate), and bamboo.

In some embodiments of versions of a device to hold a fishing rod and reel a hollow tube 002, a spacer 007, a leg plate 003 may be a single component.

In some embodiments of versions of a device to hold a fishing rod and reel there may be one strap 004 or a plurality of straps 004.

In some embodiments of versions of a device to hold a fishing rod and reel there may be a belt strap 006 or a plurality of belt straps 006.

In some embodiments of versions of a device to hold a fishing rod and reel a hollow tube 002, a spacer 007, a leg plate 003 may be separate components connected by a plurality of fasteners.

In some embodiments of versions of a device to hold a fishing rod and reel the straps 004, and belt strap 006 may be made of materials like, but not limited to, nylon webbing material, high density polyester weaving, rubber, or hook and loop materials.

In some embodiments of versions of a device to hold a fishing rod and reel the straps 004 and belt strap 006 may be of a size, not meant to be limiting, of 1.2 cm to 25 cm (approximately 0.5 inches to 10 inches) in width. The length of the straps may be, not meant to be limiting, from 30 cm to 76 cm (approximately 12 inches to 30 inches).

In some embodiments of versions of a device to hold a fishing rod and reel a buckle 005 may be used with the straps 004 and a belt strap 006.

In some embodiments of versions of a device to hold a fishing rod and reel a buckle 005 may be made of, but not limited to, plastic, Polyoxymethylene (POM), or metal.

In some embodiments of versions of a device to hold a fishing rod and reel a buckle 005 may be a snap-fit connector, a POM plastic adjustable buckle, slide-through metal buckle, or a cinch buckle.

In some embodiments of versions of a device to hold a fishing rod and reel straps 004, belt strap 006 and a buckle 005 may be a hook and loop cinch strap. A cinch ring may be ultrasonically welded to the loop end of the strap, which makes it adjustable and re-usable.

Some embodiments of versions of a device to hold a fishing rod and reel comprises the following components: (2) a hollow tube 002; (3) a molded leg plate 003 with padding; (4) two straps of a length and width to accommodate various leg sizes 004; (5) a buckle to secure the ends of each strap 005; a mechanism to tighten the straps; a belt to secure to one's waist.

In some embodiments of versions of a device and system to hold a fishing rod and reel these components are connected as follows to result in a single system: (1) a hollow tube 002 is aligned longitudinally with a leg plate 003; (2) a hollow tube 002 is connected to a leg plate 003 with a plurality of fasteners; (3) straps 004 are inserted through slots on each side of a hollow tube 002; (4) a fastener connects straps 004 to a hollow tube 002; (5) a selected buckle 005 is attached to each strap 004.

Some embodiments of versions of a device to hold a fishing rod and reel in its most complete version comprises the following components: (2) a hollow tube 002; (3) a molded leg plate 003 with padding; (4) a spacer 007 connected to a hollow tube 002 and a leg plate 003; (5) two straps 004 of a length and width to accommodate various leg sizes; (6) a belt strap 006 to secure to one's waist; (7) a buckle 005 to secure the ends of each strap 004 and a belt strap 006.

In some embodiments of versions of a device and system to hold a fishing rod and reel these components in its most complete version are connected as follows to result in a single system: (1) a hollow tube 002 is aligned longitudinally with a spacer 007 and with a leg plate 003; (2) a hollow tube 002 is connected to a spacer 007 and a leg plate 003 as a single component; (3) straps 004 are inserted through slots on each side of a spacer 007; (4) a belt strap 006 is inserted through a slot at the top end of a spacer 007 or leg plate 003 perpendicular to straps 004; (5) a selected buckle 005 is attached to straps 004 and a belt strap 006.

Embodiments of a device and system to hold a fishing rod and reel may be used on either leg.

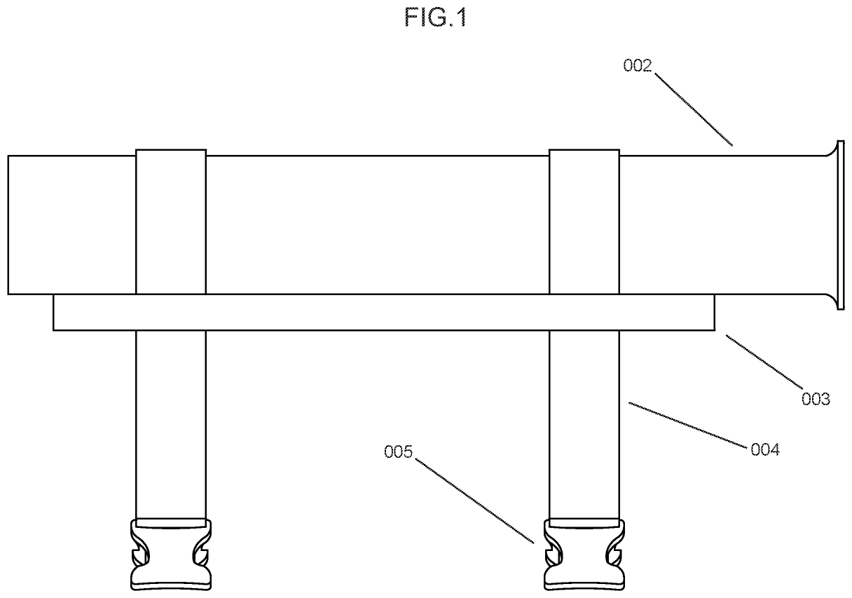

FIG. 1. A side view of the preferred basic embodiment of a device and system to hold a fishing rod and reel components, assembled; hollow tube 002, leg plate 003, two straps 004, buckle 005.

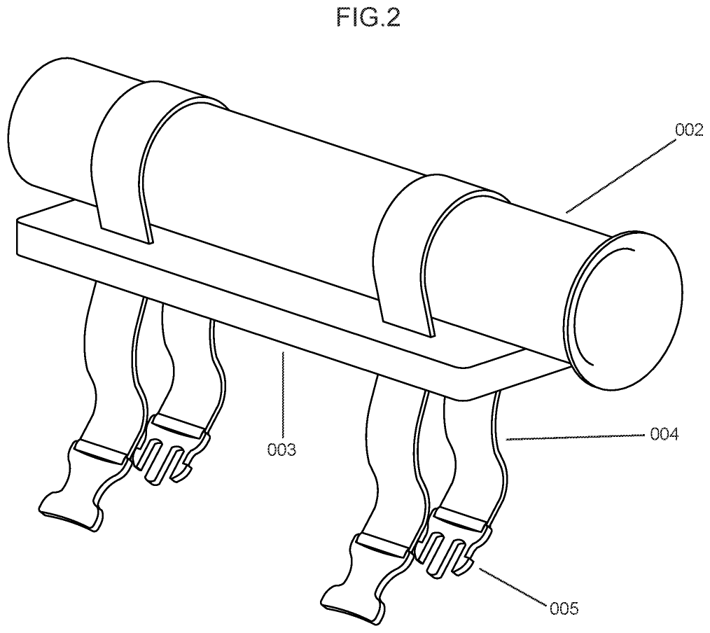

FIG. 2. A planar view of the preferred basic embodiment of a device and system to hold a fishing rod and reel components, unassembled. hollow tube 002, leg plate 003, two straps 004, buckle 005.

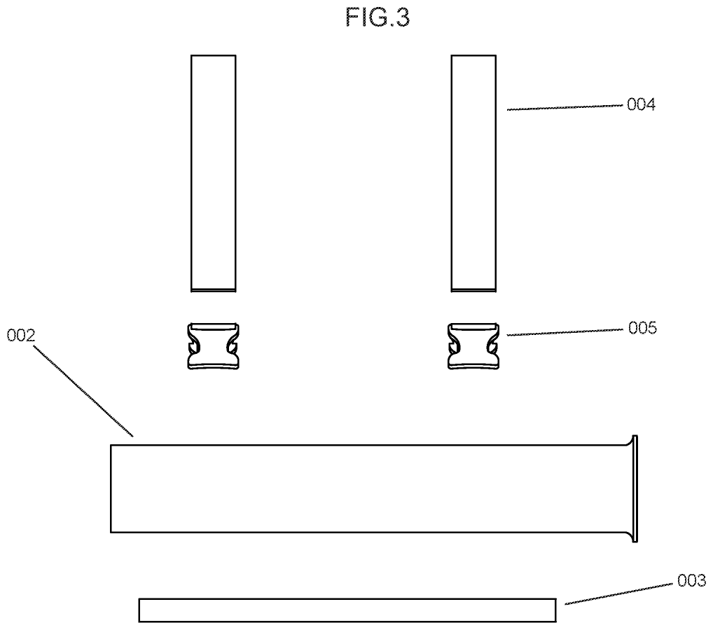

FIG. 3. A side view of a device and system to hold a fishing rod and reel assembled and attached to a hypothetical fishing rod 001, hollow tube 002, leg plate 003, two straps 004, buckle 005.

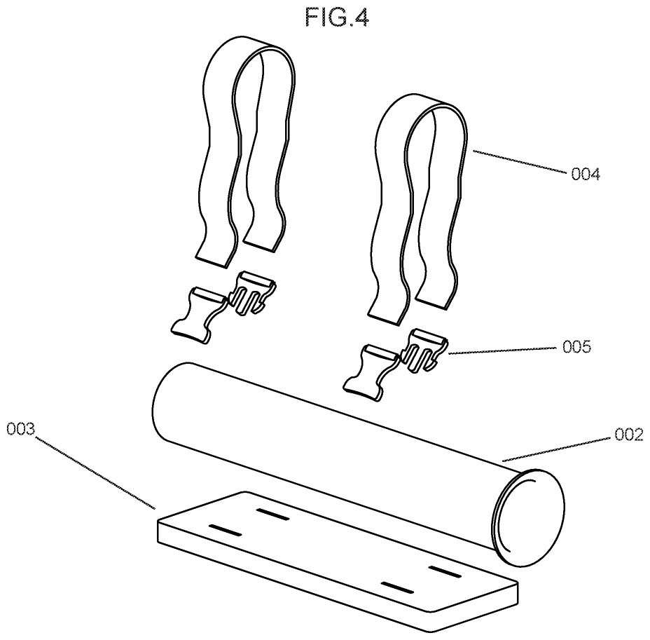

FIG. 4. A planar view of a device and system to hold a fishing rod and reel showing the unassembled components.

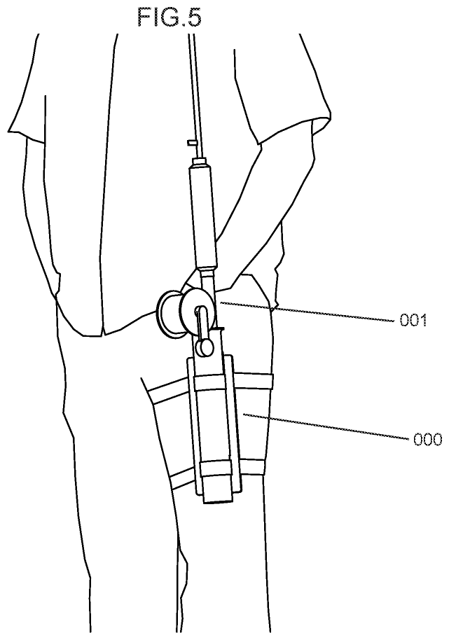

FIG. 5. A line drawing with a device and system to hold a fishing rod and reel attached to the left leg with a fishing rod in the holder.

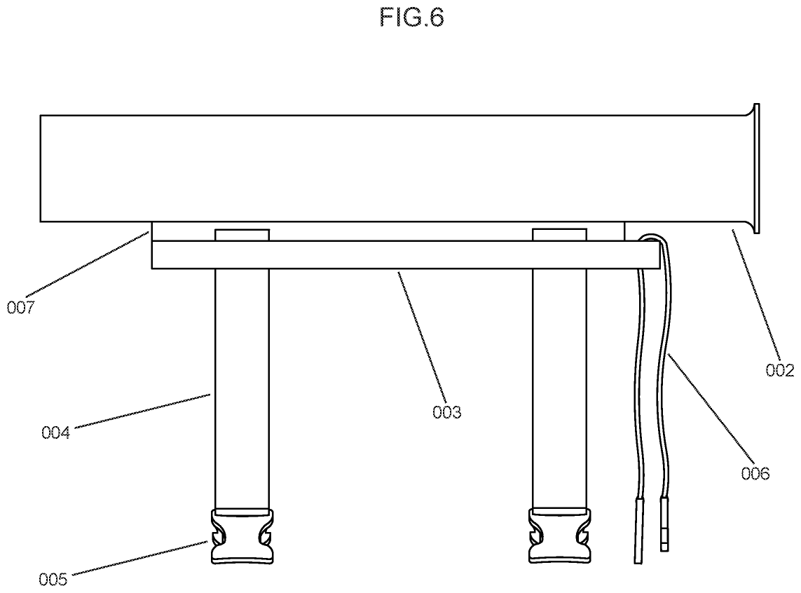

FIG. 6. A side view of a device and system to hold a fishing rod and reel including a spacer and belt strap, assembled; a hollow tube 002, a leg plate 003, two straps 004, a buckle 005, a spacer 007, a belt strap 006.

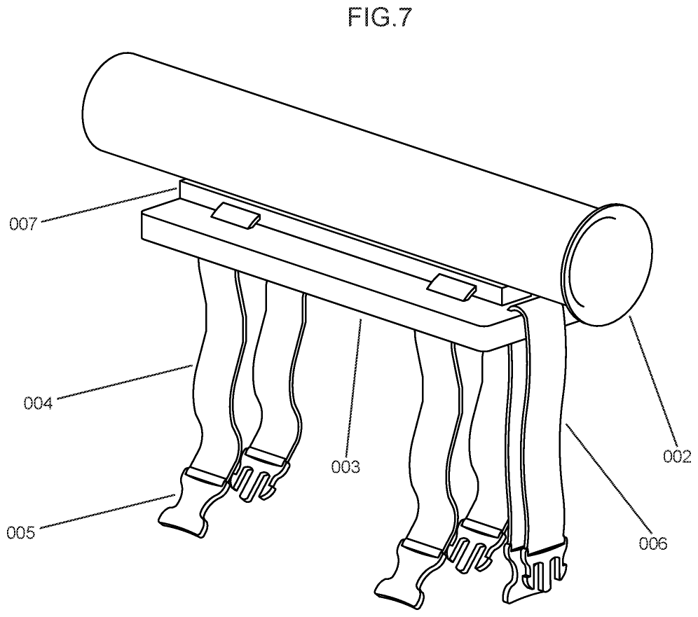

FIG. 7. A planar view of a device and system to hold a fishing rod and reel including a spacer and belt strap, assembled; a hollow tube 002, a leg plate 003, two straps 004, a buckle 005, a spacer 007, a belt strap 006.

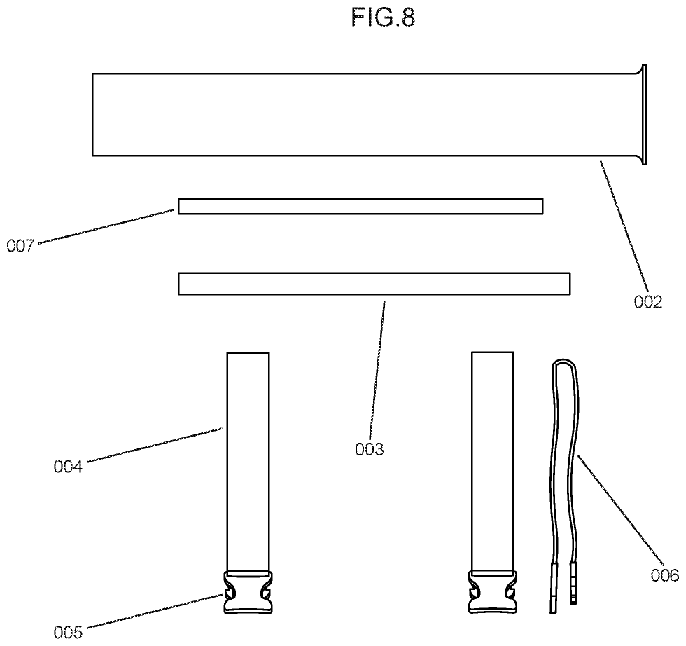

FIG. 8. A side view of a device and system to hold a fishing rod and reel including a spacer and belt strap, unassembled; a hollow tube 002, a leg plate 003, two straps 004, a buckle 005, a spacer 007, a belt strap 006.

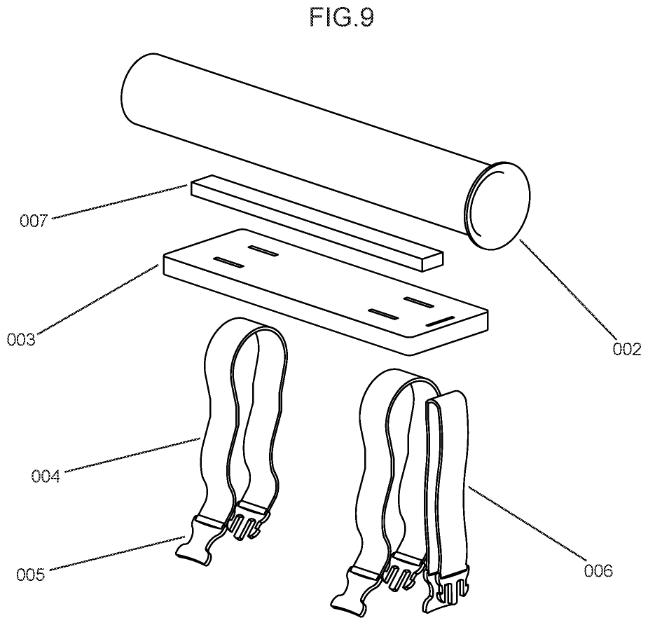

FIG. 9. A planar view of a device and system to hold a fishing rod and reel including a spacer and belt strap, unassembled; a hollow tube 002, a leg plate 003, two straps 004, a buckle 005, a spacer 007, a belt strap 006.

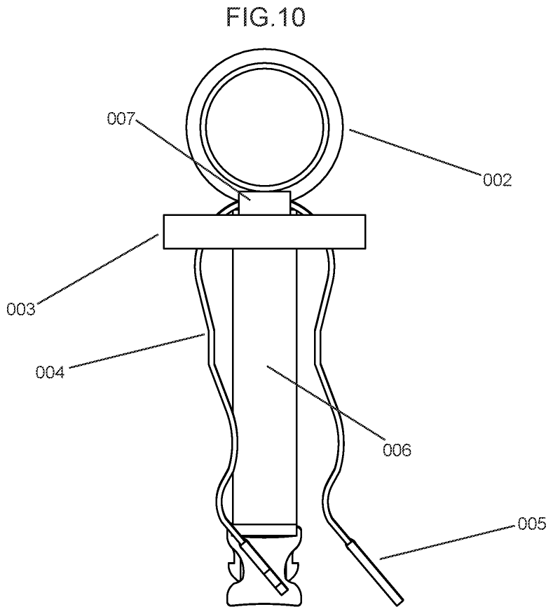

FIG. 10. A side view, rotated 90 degrees from FIG. 9, of a device and system to hold a fishing rod and reel including a spacer and belt strap, assembled; a hollow tube 002, a leg plate 003, two straps 004, a buckle 005, a spacer 007, a belt strap 006.

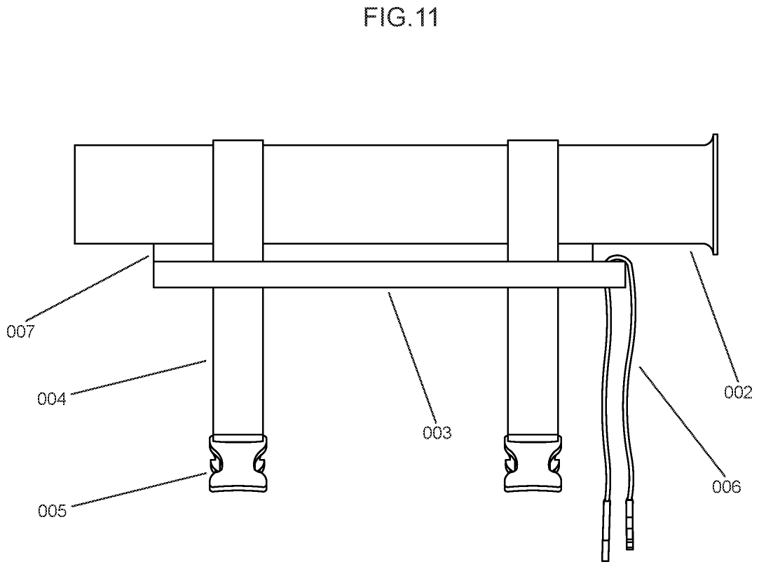

FIG. 11. A side view of a device and system to hold a fishing rod and reel including a spacer and belt strap, assembled; a hollow tube 002, a leg plate 003, two straps 004 passed through slots in a leg plate 003 around a hollow tube 002, a plurality of buckles 005, a spacer 007, a belt strap 006.

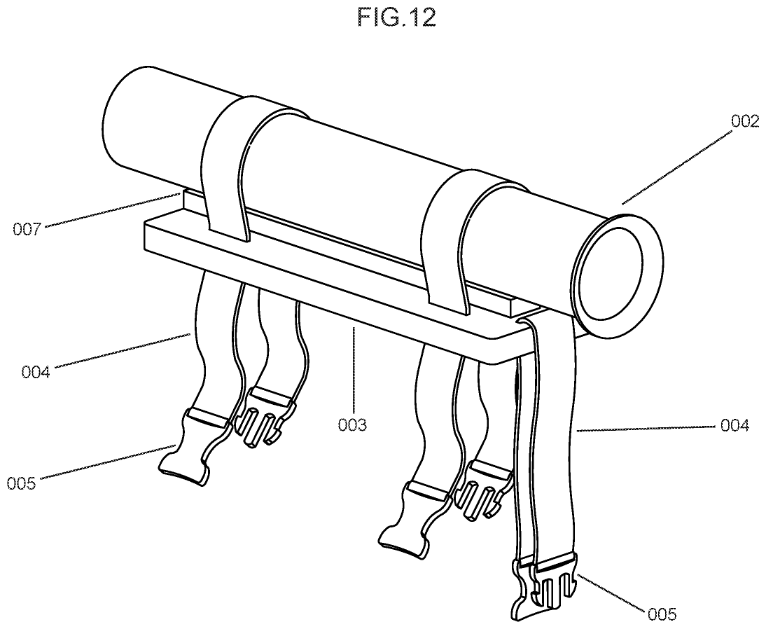

FIG. 12. A planar view of a device and system to hold a fishing rod and reel including a spacer and belt strap, assembled; a hollow tube 002, a leg plate 003, two straps 004 passed through slots in a leg plate 003 around a hollow tube 002, a plurality of buckles 005, a spacer 007, a belt strap 006.

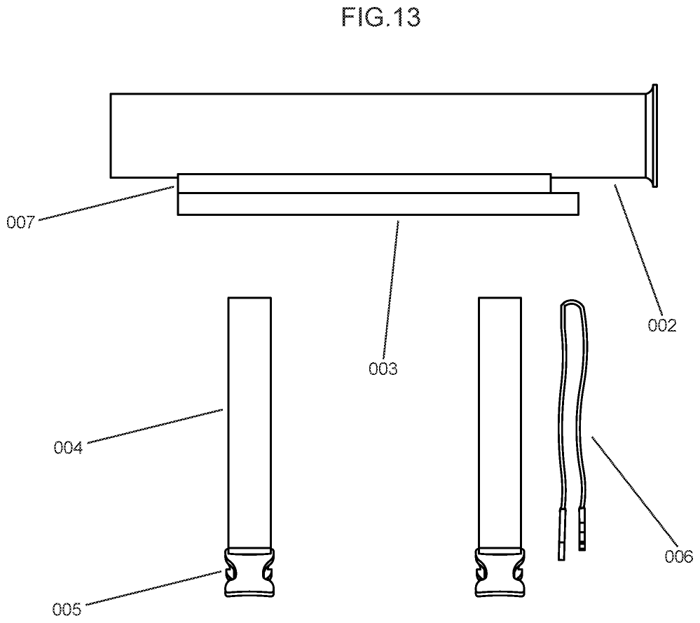

FIG. 13. A side view of a device and system to hold a fishing rod and reel including a spacer and belt strap, unassembled; a hollow tube 002, a leg plate 003, two straps 004, a plurality of buckles 005, a spacer 007, a belt strap 006.

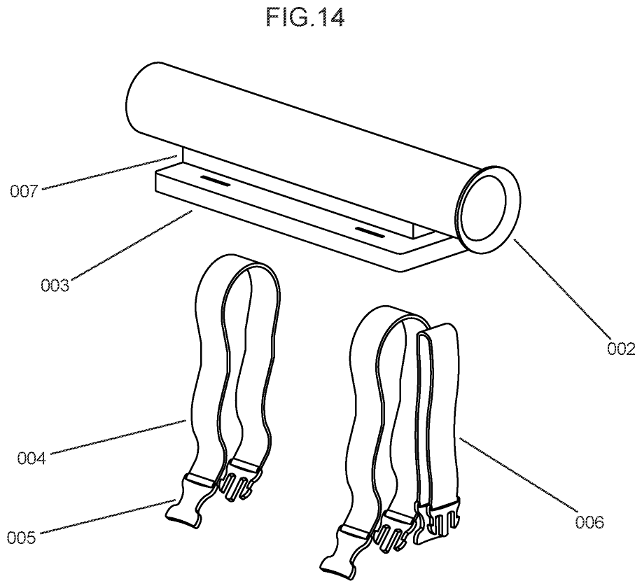

FIG. 14. A planar view of a device and system to hold a fishing rod and reel including a spacer and belt strap, unassembled; a hollow tube 002, a leg plate 003, two straps 004, a plurality of buckles 005, a spacer 007, a belt strap 006.

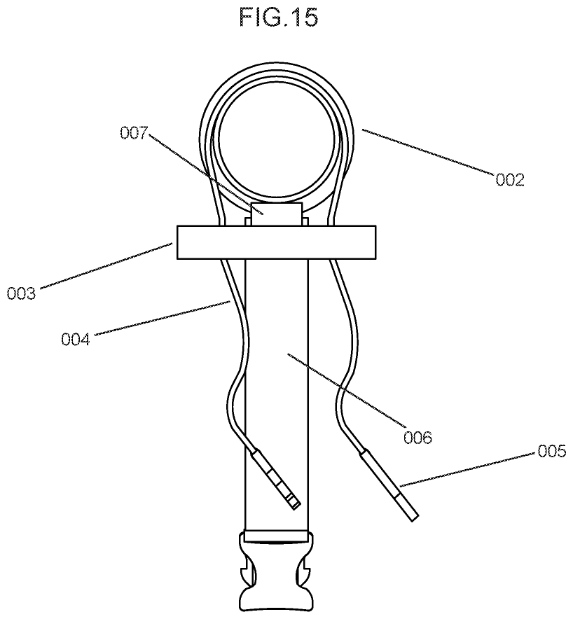

FIG. 15. A side view, rotated 90 degrees from FIG. 11, of a device and system to hold a fishing rod and reel including a spacer and belt strap, assembled; a hollow tube 002, a leg plate 003, two straps 004 passed through slots in a leg plate 003 around a hollow tube 002, a plurality of buckles 005, a spacer 007, a belt strap 006.

A version of the invention may be a method of adapting a fishing rod with a device and system to hold a fishing rod and reel, comprising: selecting a hypothetical fishing rod 001, a hollow tube 002; a leg plate 003; two straps 004; a buckle 005 to secure the ends of each strap; a mechanism to tighten the straps.

A version of the invention may be a method of adapting a fishing rod with a device and system to hold a fishing rod and reel, comprising: selecting a hypothetical fishing rod 001, a hollow tube 002; a leg plate 003; a spacer 007; two straps 004; a belt strap 006; a buckle 005 to secure the ends of each strap 004 and 006; a mechanism to tighten the straps.

Versions of a device and system to hold a fishing rod and reel may be made individually, in batches, or via continuous assembly.

For example, to make an embodiment of a version of a device and system to hold a fishing rod and reel prepare an appropriate work surface and assemble all of the components disclosed herein. Assemble the components in a logical order as someone skilled in the art would do. For example, start with a hollow tube 002; a leg plate 003; two straps 004; a buckle 005 to secure the ends of each strap; a mechanism to tighten the straps. Lay the leg plate 003 flat and ensure there are four slots in the leg plate 003 to allow the straps 004 to pass through each slot. Position the hollow tube 001 longitudinally on the leg plate 003 and parallel to the slots. The slots should be of a distance equal to the diameter of the hollow tube 002. The slots should be longitudinally distanced apart in a manner that will create the most comfort and stability. Using fasteners, connect the tube 002 to the leg plate 003. Insert the ends of the straps through the slots in the leg plate 003. Use a fastener to hold each strap 004 to the hollow tube 002. Connect the buckle 005 to the end of the straps 004.

For example, to make an embodiment of a complete version of a device and system to hold a fishing rod and reel prepare an appropriate work surface and assemble all of the components disclosed herein. Assemble the components in a logical order as someone skilled in the art would do. For example, start with a hollow tube 002 a leg plate 003 a spacer 007 as a single unit; two straps 004; a belt strap 006; a buckle 005 to secure the ends of each strap 004 and a belt strap 006. Lay the leg plate 003 a hollow tube 002 and a spacer 007 assembly flat and ensure there are slots in the leg plate 003, as desired but not required, and a spacer 007 to allow the straps 004 to pass through each slot. The slots for the straps 004 should be longitudinally distanced apart in a manner that will create the most comfort and stability. A belt strap 006 should pass through a perpendicular slot at the “top end” of the device. Insert the ends of the straps 004, 006 through the slots in the spacer 007 and leg plate 003. Connect the buckle 005 to the end of the straps 004, 006.

Another example to use the assembled version of a device and system to hold a fishing rod and reel comprises placing the straps around the thigh. Connect the straps with the buckle. Tighten the straps to hold a device and system to hold a fishing rod and reel securely to the leg. Select an appropriate fishing rod and insert the rod handle downward into the hollow tube. Let go of the fishing rod.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

The embodiments of a device and system to hold a fishing rod and reel may be utilized individually, concurrently, or in any sequential combination.

Those skilled in the art to which this application relates will appreciate that other and further additions, deletions, substitutions and modifications may be made to the described embodiments.

The specification is not to be taken in a limiting sense, but is made merely for the purpose of describing the general principles of exemplary embodiments; many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

The invention is described with such embodiments, but the invention is not limited to any embodiment. The scope of the invention is limited only by the claims and the invention encompasses numerous alternatives, modifications and equivalents. Several specific details are set forth in the description to provide a thorough understanding of the invention. These details are provided for the purpose of example and the invention may be practiced according to the claims without some or all of these specific details. In general, the order of the steps of disclosed processes may be altered within the scope of the invention.

Unless otherwise indicated, the drawings are intended to be read (e.g., arrangement of parts, proportion, degree, etc.) together with the specifications, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

What is claimed:

1. A device and system to hold a fishing rod and reel, comprising:
a hollow tube of a given height, thickness, and diameter;
a leg plate of a given height, thickness, and width;
a spacer of a given height, thickness, and width;
a plurality of slots in the leg plate; and
a plurality of straps and buckles.

2. The device and system to hold a fishing rod and reel of claim 1 wherein the hollow tube, leg plate, and spacer are separate components connected together.

3. The device and system to hold a fishing rod and reel of claim 1 wherein the hollow tube, leg plate, and spacer are a single component.

4. The device and system to hold a fishing rod and reel of claim 1 wherein the hollow tube, leg plate, and spacer are made from a material selected from the group consisting of metal, plastic, fiberglass, carbon fiber, rubber, foam, PVC (polyvinyl acetate), EVA (ethylene-vinyl acetate), and bamboo.

5. The device and system to hold a fishing rod and reel of claim 1 wherein the hollow tube further comprising a flared upper end.

6. The device and system to hold a fishing rod and reel of claim 1 wherein the straps pass through slots in the leg plate, around the hollow tube, and through the slots on the leg plate.

7. The device and system to hold a fishing rod and reel of claim 1 wherein the straps pass through slots in the leg plate.

8. The device and system to hold a fishing rod and reel of claim 1 wherein the buckles are attached to the straps.

9. The device and system to hold a fishing rod and reel of claim 1 further comprising a fishing rod and reel.

10. A system to hold a fishing rod and reel, comprising:
a hollow tube of a given height, thickness, and diameter;
a leg plate of a given height, thickness, and width;
a spacer of a given height, thickness, and width;
a plurality of slots in the leg plate; and
a plurality of straps and buckles.

11. A method of using a fishing rod with a device and system to hold a fishing rod and reel, comprising:
selecting a fishing rod appropriate for a device and system to hold a fishing rod and reel; and
using a device and system to hold a fishing rod and reel comprising a hollow tube, a leg plate, a spacer, a plurality of slots, and a plurality of straps and buckles; and
wherein placing the fishing rod in a device and system to hold a fishing rod and reel allows hands-free and safe use of the fishing rod.
